(19) United States
(12) Patent Application Publication
(10) Pub. No.: US 2009/0298008 A1
(43) Pub. Date: Dec. 3, 2009

(54) DENTAL X-RAY AND DRILL GUIDE APPARATUS AND METHOD

(75) Inventors: Randall Clayton Groscurth, Troy, MI (US); Shoko Ueno Groscurth, Troy, MI (US)

Correspondence Address: YOUNG BASILE, 3001 WEST BIG BEAVER ROAD, SUITE 624, TROY, MI, 48084, US

(73) Assignee: IBUR, L.L.C., Troy, MI (US)

(21) Appl. No.: 12/129,531

(22) Filed: May 29, 2008

(51) Int. Cl. A61C 19/00

(52) U.S. Cl. 433/74

(57) ABSTRACT

An apparatus and method for performing a dental procedure relating to replacement of teeth includes a dental model made from an impression of teeth and gums of a particular mouth formation of a patient and an intended dental implant location with respect to the dental model. A reference member to be supported by the dental model is located in a desired angulation and dimensional position at the intended dental implant location. Each reference member includes a base portion having at least a partial spherical surface for engagement within an at least partial spherical aperture formed in the dental model with a round ball drill. The base portion supports an outwardly extending reference pin portion. A material to be applied around the one or more reference members provides support for each of the reference members when the material has hardened.

### FIELD OF THE INVENTION

The invention relates to an apparatus and method for performing a dental procedure relating to replacement of teeth including a dental model of a particular mouth formation of a patient, and an intended dental implant location with respect to the dental model, and more particularly to the production and use of a dental X-ray guide and/or a dental drill guide during a dental procedure relating to replacement of teeth.

### BACKGROUND

The popularity of dental implants has grown greatly in recent years, and the implant placement has become a part of the routine dental work in many dentists' offices. X-ray guides are used to verify the location and the angulations of implants when usage of a CT scan is unjustifiable, and implant drill guides are used at the surgeries to place implants into the desired location with the proper angulation. However, these devices are not often used, especially when a small number of implants are placed in one surgery, even though wrong location, spacing, and angulations of implant placement may compromise the esthetic result of the final dental restoration. The reason of this tendency is thought to be the amount of labor involved in making surgical guide devices and the high price of custom order-made devices.

It is known to take an impression of a particular mouth formation of a patient to create a dental model when preparing for a dental procedure relating to replacement of teeth. The dental model is typically made at a dental laboratory separate from the dental office requiring the patient to make several different appointments with the dentist to complete the necessary procedures. The dental model is drilled at the dental laboratory with a smooth cylindrical aperture in a desired location for implant placement indicated by the dentist. A locator rod is inserted into the smooth cylindrical bore and a drill guide support is located by the locator rod during formation of a drill guide impression tray on the dental model at the dental laboratory. The drill guide support can be of the type illustrated in FIGS. 5B-5D with replaceable drill guides of different diameters as illustrated in FIGS. 5E-5G. The proper fit, spacing, location and angulation of the drill guide is checked by the dentist in the dental office when the patient returns for another appointment during a dental tooth replacement procedure. If the drill guide fit, spacing, location or angulation is incorrect, the dentist returns the tray to the dental laboratory for correction, and reschedules another appointment for the patient. Correction of the fit, spacing, location, or angulation can require filling the cylindrical bore in the dental model and redrilling another cylindrical bore at different spacing, location and/or angulation as directed by instructions from the dentist. In some cases, another dental model of the mouth formation of the patient may be required to accomplish the corrections requested by the dentist.

It would be desirable to provide a dental implant procedure that could be performed at the dental office while the patient waits to reduce or eliminate repeated return visits by the patient for the complete dental implant procedure. It would be desirable to provide a dental X-ray tray to verify spacing, placement and angulation of each drill guide with respect to the particular patient prior to fabrication of the surgical drill guide tray. It would be desirable to provide a dentist with an option to create an X-ray tray and/or a drill guide in the dentist office without requiring the delay associated with work required to be done in a dental laboratory. It would be desirable to provide a dental procedure with easy adjustment of location and angulation of implant placement with respect to the dental model to accomplish any corrections required as a result of verification checking against the particular mouth formation of a patient.

### SUMMARY

The invention can be used to create an X-ray guide for verification of locations and angulations of the implant placement, and/or to create an accurate custom drill guide for dental implant placement surgery. The components necessary to make the guides can be used in a dental laboratory or a dentist office for making the X-ray guide and/or drill guide easily and quickly. The components allow a dentist or technician to establish the ideal location, spacing, and angulations of implants on the dental model using a combination of a pin with a sphere at the base of the pin, and to easily create the surgical guide or guides that accommodate all the different size surgical drills used in the surgery by building the guide around the pin.

The components include: (1) a spacing/positioning/orientation sphere and pin combination; (2) a surgical guide and locator attachment that can accommodate a large variety of surgical drills sizes: and (3) a material that can be cured or hardened. The material can be used alone to build an impression tray or can be used in combination with a preformed X-ray impression tray and/or a preformed surgical guide impression tray.

An apparatus and method for performing a dental procedure relating to replacement of teeth includes a dental model of a particular mouth formation of a patient and an intended dental implant location with respect to the dental model. At least one reference member to be supported by a dental model is located in an angulation and dimensional position at an intended dental implant location. A material to be applied around the at least one reference member provides support for the at least one reference member when the material has hardened. The material forms an impression of teeth and gums of a particular mouth formation of a patient and an intended dental implant location with respect to the dental model.

An apparatus and method for performing a dental procedure relating to replacement of teeth includes a dental model made from an impression of teeth and gums of a particular mouth formation of a patient and an intended dental implant location with respect to the dental model. At least one reference member to be supported by the dental model is located in an adjustable angulation and dimensional position at the intended dental implant location. Each reference member includes a base portion having at least a partial spherical surface for engagement within an at least partial spherical aperture formed in the dental model with a round ball drill. The base portion supports an outwardly extending reference pin portion. A material to be applied around the at least one reference member provides support for the at least one reference member when the material has hardened. The material forms an impression of teeth and gums of a particular mouth formation of a patient and an intended dental implant location with respect to the dental model.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a perspective view of a dental model of a particular mouth formation of a patient having an at least partial spherical aperture drilled at an intended dental implant location and an at least partial sphere and pin combination reference member adjustably secured within the spherical aperture for verifying angulation and dimensional position of the implant at the intended dental implant location;

FIG. 2 is a perspective view of an impression tray with a cut out portion exposing the intended dental implant location including the sphere and pin combination reference member adjustably secured within the spherical aperture of the dental model;

FIG. 3 is a perspective view of a completed X-ray guide impression tray for verifying angulation and dimensional position of the implant at the intended dental implant location for a particular mouth formation of a patient with an X-ray film exposure;

FIGS. 4A-4C are exploded perspective views of an at least partial sphere and pin combination reference member with various diameter pins corresponding to various drill diameters necessary for a dental surgical implant procedure to be performed on a particular mouth formation of a patient;

FIG. 5A is a perspective view of a fixed attachment guide engageable with respect to a sphere and pin combination reference member with various drill guide diameters for a dental implant procedure to be performed on a particular mouth formation of a patient,

FIGS. 5B-5G are perspective views of a prior art drill guide support and replaceable drill guides of various diameter that have been used with a prior art cylindrical rod to be supported in a smooth cylindrical bore formed in a dental model;

FIG. 6 is a perspective view of an impression tray with a cut out portion to expose an intended dental implant location and reference members supporting replaceable attachment guides with locator attachments for creating a surgical guide tray;

FIG. 7 is a perspective view of the impression tray of FIG. 6 with an anchor portion of the replaceable attachment guides secured to the impression tray, the pin portion of the reference members removed, and the locator attachments exposed for removal and replacement with drill guide attachments of any required diameter for a dental implant procedure to be performed on a particular mouth formation of a patient;

FIGS. 8A-8E are perspective views of pin sleeves for enlarging a diameter of the pin portion of a reference member for locating drill guide attachments of various diameters for a dental implant procedure to be performed on a particular mouth formation of a patient;

FIGS. 9A-9D are plan views of replaceable locator attachments of various diameters with fixed widths;

FIGS. 10A-10D are plan views of replaceable locator attachments of various diameters with variable widths;

FIGS. 11A-11D are plan views of replaceable drill guide attachments of various diameters with fixed widths;

FIGS. 12A-12D are plan view of replaceable drill guide attachments of various diameters with variable widths;

FIG. 13 is a plan view of a drill guide attachment illustrating width of the attachment, height of radius of the attachment, and width of slot of the attachment;

FIG. 14 is a plan view of first and second complementary T-shaped attachment portions connecting an anchor portion or base portion with a replaceable locator attachment or a replaceable drill guide attachment;

FIGS. 15A-15B are a perspective views of another first complementary T-shaped attachment portion for connecting an anchor portion or base portion with a replaceable locator attachment or a replaceable drill guide attachment;

FIG. 16 is a perspective view of first complementary Y-shaped attachment portion for connecting an anchor portion or base portion with a replaceable locator attachment or a replaceable drill guide attachment;

FIG. 17 is a perspective view of first complementary dual bayonet shaped attachment portion for connecting an anchor portion or base portion with a replaceable locator attachment or a replaceable drill guide attachment;

FIGS. 18A-18B are a perspective views of first and second complementary dual bayonet shaped attachment portions for connecting an anchor portion or base portion with a replaceable locator attachment or a replaceable drill guide attachment;

FIGS. 19A-19B are an elevational views of first and second complementary plurality of bayonet shaped attachment portions connecting an anchor portion or base portion with a replaceable locator attachment or a replaceable drill guide attachment;

FIG. 20A-20B are a perspective views of first complementary single elliptical bayonet shaped attachment portions for connecting an anchor portion or base portion with a replaceable locator attachment or a replaceable drill guide attachment;

FIG. 21 is a perspective view of first and second complementary dual bayonet shaped attachment portions connecting an anchor portion or base portion with a replaceable locator attachment or a replaceable drill guide attachment;

FIGS. 22A-22B are perspective views of a drill guide anchor or base portion having a vertically extending key-hole-shaped slot;

FIGS. 23A-23H are perspective views of a complementary non-circular bayonet shaped attachment portion for connecting to the base portion of FIGS. 22A-22B;

FIGS. 24A-24C are perspective views of replaceable drill guides using a bayonet shaped attachment portion of the type shown in FIGS. 22A-23H;

FIG. 25 is a perspective view of a ball and pin combination with a shaped outer end for engagement with a male fixture on an outer end to allow use of a tool to securely seat the pin with respect to the ball and to adjust angulation of different size pins with respect to the ball;

FIG. 26 is a front view of a pin having an anchor preform for forming an anchor portion for a large size dental implant drill guide, the pin having a cylindrical stub for engagement within a cylindrical aperture formed in the dental model or for engagement with a cylindrical aperture formed in the spherical ball portion;

FIG. 27 is a bottom view of the pin having a replaceable anchor preform of FIG. 26 for a large size dental implant drill guide;

FIG. 28 is a front view of a pin having a replaceable anchor perform for a small size dental implant drill guides the pin having a cylindrical stub for engagement with a cylindrical aperture formed in the dental model or for engagement with a cylindrical aperture formed in the spherical ball portion;

FIG. 29 is a bottom view of the pin having a replaceable anchor preform of FIG. 28 for a small size dental implant drill guide;

FIG. 30 is a front view of a pin having an anchor preform for forming an anchor portion for a large size dental implant drill guide, the pin having a cylindrical aperture for engagement with a cylindrical stub supported from the dental model or for engagement with a cylindrical stub supported from the spherical ball portion;

FIG. 31 is a bottom view of the pin having a replaceable anchor preform of FIG. 30 for a large size dental implant drill guide;

FIG. 32 is a front view of a pin having a replaceable anchor perform for a small size dental implant drill guide the pin having a cylindrical aperture for engagement with a cylindrical stub supported from the dental model or for engagement with a cylindrical stub supported from the spherical ball portion; and

FIG. 33 is a bottom view of the pin having a replaceable anchor preform of FIG. 32 for a small size dental implant drill guide.

### DETAILED DESCRIPTION

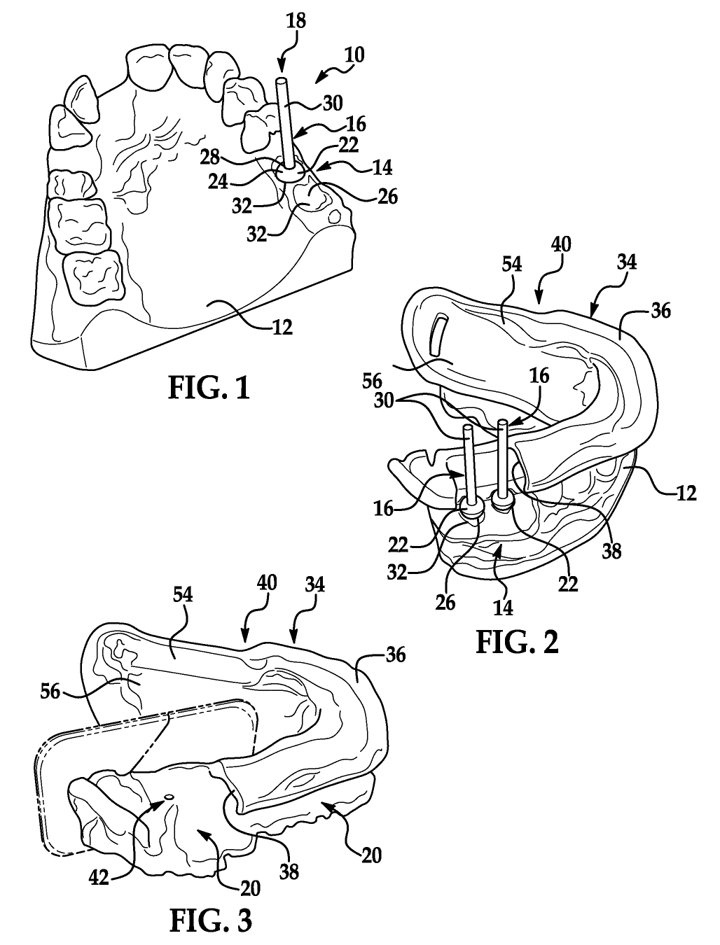

Referring now to FIG. 1, an apparatus 10 according to an embodiment of the invention is illustrated for performing a dental procedure relating to replacement of teeth including a dental model 12 of a particular mouth formation of a patient and at least one intended dental implant location 14 with respect to the dental model 12. At least one reference member 16 is supported by the dental model 12 in an adjustable angulation and dimensional position 18 at an intended dental implant location 14. A material 20 is applied around the at least one reference member 16 for supporting each reference member when the material 20 is hardened or cured. The material 20 forms an impression of teeth and gums of a particular mouth formation of a patient and an intended dental implant location 14 with respect to the dental model 12.

Suitable material 20 is available commercially under different names from various manufacturers. By way of example and not limitation, a suitable heavy body PVS material 20 can include FRESH® from Exacta Dental Direct of Clinton Township, Mich.; AQUASIL-SMART WETTING® impression material from Dentsply of Burlington, N.J.; or IMPRINT™ II Penta from 3M ESPE of Saint Paul Minn. By way of example and not limitation, a suitable light cured composite material 20 can include TRIAD® custom tray material from Dentsply Prosthetics of York, Pa.; or FASTRAY LC™ from Bosworth of Skokie, Ill.

Referring now to FIGS. 1,2 and 4A-4C, each reference member can include a base member or ball portion 22 having at least a partial spherical surface 24 for engagement within an aperture 26 formed in the dental model 12 with a round ball drill. The base portion 22 can include a pin-receiving aperture 28. A pin 30 can be engaged within the pin-receiving aperture 28 of the base member 22. The base member 22 can be substantially spherically shaped if desired. The pin 30 is releasibly engageable within the pin-receiving aperture 28. The pin 30 can be engaged within the base member by a threaded connection or with a friction fit connection. It should be recognized that the ball 22 and pin 30 can be formed as a single member, if desired. It should further be recognized that the if a separate ball portion 22 is provided, that the ball portion 22 can include an outwardly projection stub for attachment of the pin 30 in place of the pin-receiving aperture 28, where the pin includes a corresponding stub-receiving aperture, or a mating collar can couple the stub and pin together, if desired.

An adhesive 32 is provided for releasibly securing each reference member 16 in the desired angulation and dimensional position l 8 with respect to the dental model 12. A suitable adhesive 32 is available commercially from various manufacturers under different names. By way of example and not limitation, a suitable adhesive 32 can include ZAPIT® from Dental Ventures of Corona, Calif.; or SUPER GLUE® from Renpert of Saint Charles, Ill.

An adhesive release agent can be applied to the dental model 12 to release a reference member 16 for readjustment of the angulation and dimensional position 18 or for removal of the reference member 16. A suitable release agent is available commercially from various manufacturers under different names. By way of example and not limitation, a suitable release agent can include acetone, or a nail polish remover.

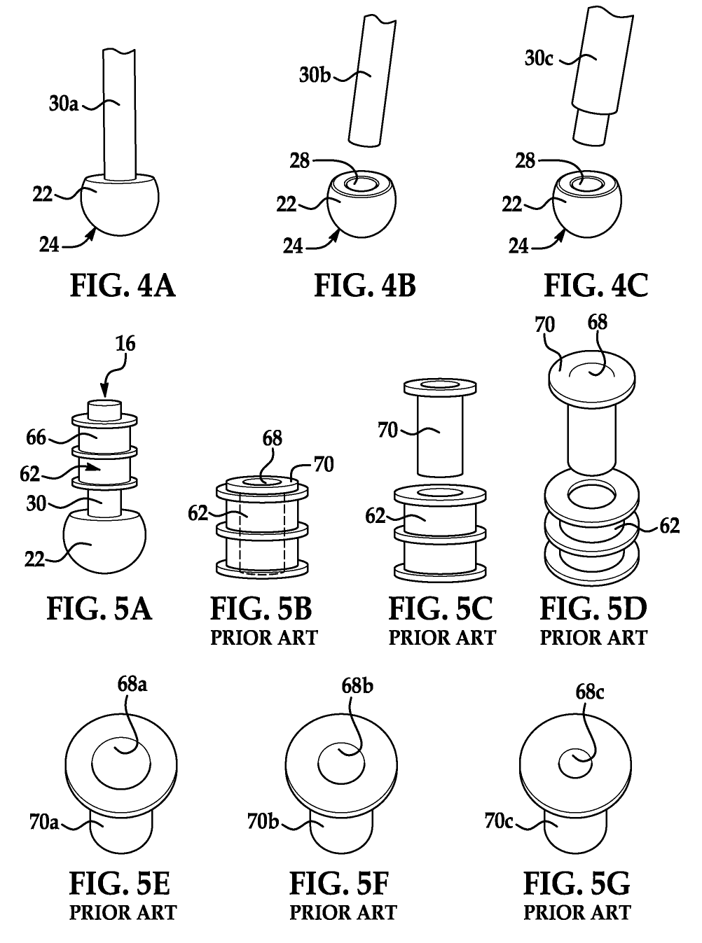

The pins 30a, 30b, 30c illustrated in FIGS. 4A-4C illustrate pins of varying diameters to support different size surgical drill locators from the same base portion 22 of each reference member 16, as will be discussed in greater detail below.

Referring now to FIGS. 2 and 3, an impression tray 34 is formed with respect to the dental model 12 made from an impression of teeth and gums of a particular mouth formation of a patient. The material 20 can be used by itself to create the impression tray, or the material 20 can be used in combination with a preformed impression tray 36.

Suitable impression trays 34 are available commercially under different names from various manufacturers. By way of example and not limitation, suitable impression tray 34 can include a disposable plastic impression tray from Patterson Dental of Saint Paul, Minn.; an impression tray from Miradent of Boston, Mass.; or a BORDER-LOCK™ implant tray from Accu-liner Products of Woodinville, Wash.

When used in combination with a preformed impression tray 36, an appropriate portion 38 of the tray 36 is cut back to expose the intended dental implant location 14 with respect to the dental model 12. The material 20 can be applied to the preformed impression tray 36 prior to placement on the dental model 12. Additional material 20 is applied within the cut back portion 3 8 of the preformed impression tray 36 to support each reference member 16 with the material has hardened or cured.

When the impression tray 34 to be formed is an X-ray guide impression tray 40, at least one X-ray visible or opaque reference member 42 is substituted for the pin portion 30 of each reference member 16. The X-ray visible reference member 42 is supported by the hardened or cured material 20 applied within the cut back portion 38 of the preformed impression tray 36. It should be recognized that the X-ray visible reference member 42 can also be supported by the hardened or cured material 20, when the material 20 has been used to create the entire impression tray 34 without a preformed tray 36. While each X-ray visible reference member is supported by the material 20, the X-ray guide impression tray 40 is transferred to the mouth of a patient for X-ray confirmation of the angulation and dimensional position 18 of the at least one X-ray visible reference member 42.

Referring now to FIGS. 5A-5G, 6 and 7, when the impression tray 34 to be formed is a surgical guide impression tray 60, at least one drill guide attachment 62 is supported by the impression tray 34 and includes a surface 64 adapted to be contacted by a dental drill tool to govern movement of the dental drill tool facilitating replacement of teeth. A structure 66 is provided for cooperatively securing a drill guide attachment 62 to the surgical guide impression tray 60. The structure 66 is formed by material 20 to be applied to the surgical guide impression tray 60 prior to placement on the dental model 12. The material 20 is also applied around the at least one drill guide attachment 62 for supporting each drill guide attachment 62 within a cut back portion 38 of a preformed tray 36 when the material 20 has hardened or cured. It should be recognized that the drill guide attachment 62 can also be supported by the hardened or cured material 20, when the material 20 has been used to create the entire impression tray 34 without a preformed tray 36. FIGS. 5A-5G illustrate a drill guide attachment 62 engageable on a pin 30 portion of a reference member 16 supported from a dental model 12 in the desired angulation and dimensional position 18. The drill guide attachment 62 can include a guide surface 68 of the appropriate size to guide a particular surgical drill for the dental implant procedure to be performed on a patient, or can support an insert 70 having a guide surface 68 of a desired dimension or size to guide a particular size surgical drill for the dental implant procedure to be performed on a patient. FIGS. 5C-5D show how the insert 70 can be placed into and removed from the drill guide attachment 62. FIGS. 5E-FG illustrate inserts 70a, 70b, 70c having different diameter guide surfaces 68a, 68b, 68c for guiding different size surgical drills for the dental implant procedure to be performed on a patient.

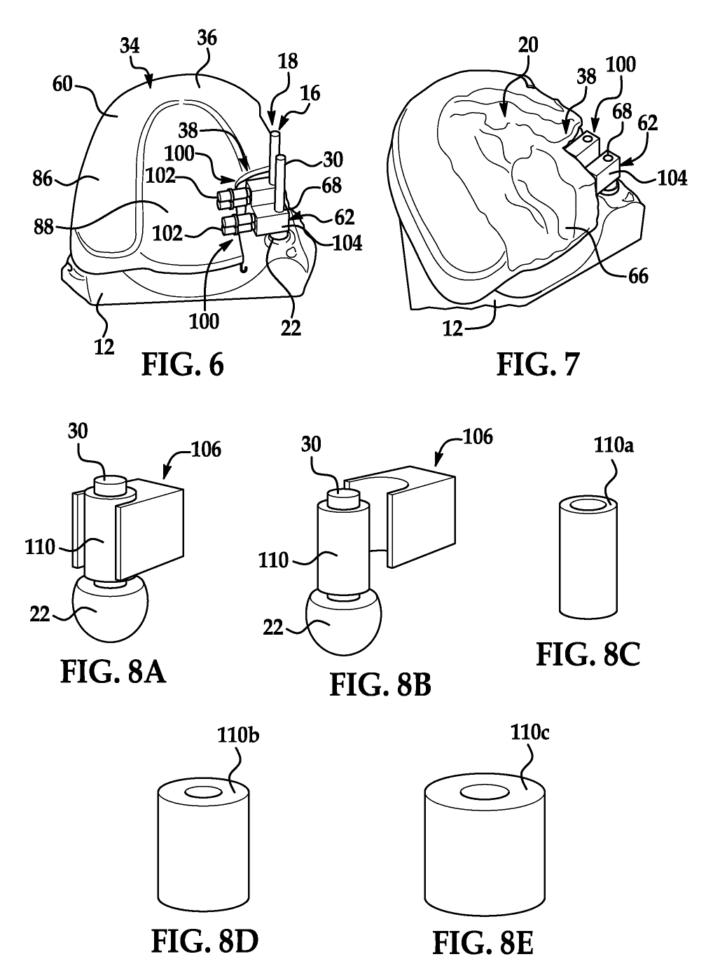

Referring again to FIGS. 6 and 7, an impression tray 34 or surgical guide tray 60 is placed on the dental model 12 with material 20 to form an impression of the teeth and gum area of a particular mouth formation of a patient. A cut back portion 38 of the preformed impression tray 36 exposes the intended dental implant location. At least one reference member 16 has previously been secured to the dental model 12 in the desired angulation and dimensional position as verified with the X-ray guide tray discussed in detail above. A drill guide attachment 62 is supported by the pin 30 portion of each reference member 16. By way of example and not limitation, the drill guide attachment 62 illustrated in FIGS. 6 and 7 is a removable attachment 100 including a base or anchor portion 102 and a removable locator portion 104. After the drill guide attachment 62 has been positioned on the pin 30 and positioned with respect to the preformed impression tray 36 as shown in FIG. 6, material 20 is applied around the base or anchor portion 102 of the removable attachment 100. When the material 20 has hardened or cured as shown in FIG. 7, the pin 30 portion of each reference member 16 is removed from the base portion or member 22. The locator portion 104 can be removed and replaced with a drill guide portion 106 in the desired size for the first phase of the surgical implant procedure to be performed on the patient. Typically this entails the use of a small diameter drill to create a pilot aperture in the corresponding bone structure of the patient in the intended dental implant location 14. Progressively larger size drill guide portions 106 are substituted in position with respect to the anchor portion 102 of the guide attachment 62 supported from the surgical guide tray 60 during the surgical procedure until an aperture of suitable size to receive the implant has been created. It should be recognized that fixed drill guides 108 can be supported from the surgical guide tray 60 if desired, and that multiple surgical guide trays 60 can be created with fixed drill guides 108 of various sizes for the surgical implant procedure to be performed on a patient. It should also be recognized that the locator portions 104 can also be used, if desired, as drill guides if appropriately sized for guiding a particular size surgical drill, or if used in combination with inserts 70 having the desired drill guide surface 68 as previously described above. It should also be recognized that the drill guide portions 106 can be used as locator portions 104, if desired, provided that sufficient care is taken to insure that the drill guide portion 106 is firmly seated against the pin 30 portion of the reference member 16 to obtain the desired angulation and dimensional position prior to applying the material 20 to be hardened or cured to fix the drill guide portions 106 in place. It should also be recognized that the anchor portion 102 and the corresponding releasable interconnecting locator guide portion 104 and/or drill guide portion 106 define a complementary interface surfaces for releasibly attaching different locator portions 104 and/or different drill guide portions 106 to a particular anchor portion 102. The complementary interface surfaces can be any desired configuration suitable for releasibly attaching the separate replaceable pieces to one another while providing a stable interlocking joint or coupling in at least two orthogonal directions, and are not limited to the various configurations shown in the attached drawing figures.

Referring now to FIGS. 8A-8E, an embodiment of the invention can include spacers 1 10 for engagement with the pin 30 portion of a reference member 16 to locate a locator portion 104 or drill guide portion 106 having a dimension greater than the pin 30. This configuration can be used as an alternative to the different dimension pins 30 illustrated in FIGS. 4A-4C described in detail above. FIGS. 8A and 8B illustrate engagement of the spacer 110 with a locator portion 104 or drill guide portion 106. FIGS. 8C-8E illustrate spacers 110a, 110b, 110c of different dimensions to accommodate locator portions 104 or drill guide portions 106 of various dimensions required for a particular dental implant surgical procedure.

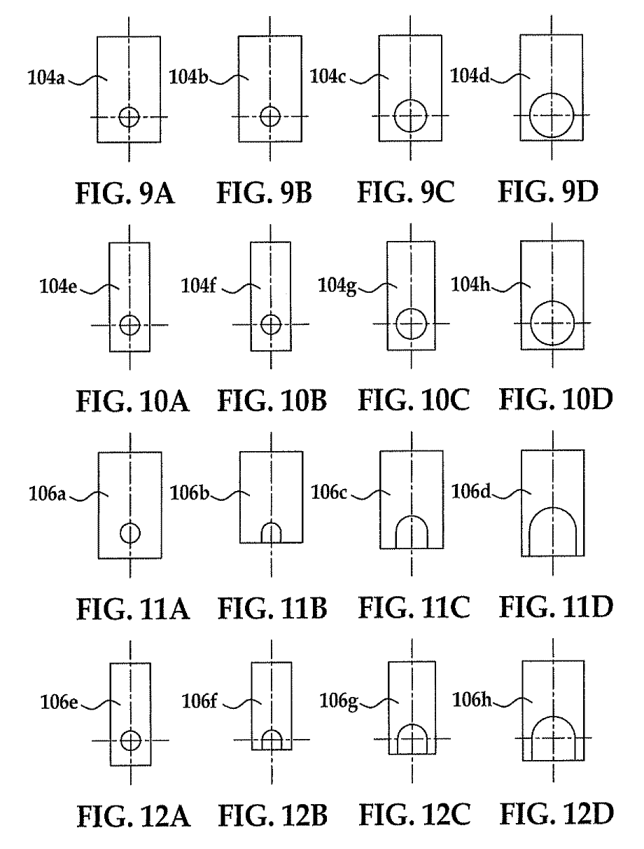

Referring now to FIGS. 9A-9D, locator portions 104a, 104b, 104c, 104d are illustrated having different locator diameter dimensions for engagement with different size pin 30 portions of a reference member 16 or with different size spacers 110 supported by the pin 30 portion of a reference member 16. The locator portions 104a-104d illustrate a set of fixed width drill guide attachments 62.

Referring now to FIGS. 10A-10D, locator portions 104e, 104f, 104g, 104h are illustrated having different locator diameter dimensions for engagement with different size pin 30 portions of a reference member 16 or with different size spacers 110 supported by the pin 30 portion of a reference member 16. The locator portions 104e-104h illustrate a set of variable width drill guide attachments 62.

Referring now to FIGS. 11A-11D, drill guide portions 106a, 106b, 106c, 106d are illustrated having different drill guide diameter aperture dimensions for engagement with different size surgical drill tools to be used during an implant procedure for a particular patient. The drill guide portions 106a-106d illustrate a set of fixed width drill guide attachments 62.

Referring now to FIGS. 12A-12D, locator portions 106e, 106f, 106g, 106h are illustrated having different drill guide diameter aperture dimensions for engagement with different size surgical drill tools to be used during an implant procedure for a particular patient. The drill guide portions 106e-106h illustrate a set of variable width drill guide attachments 62.

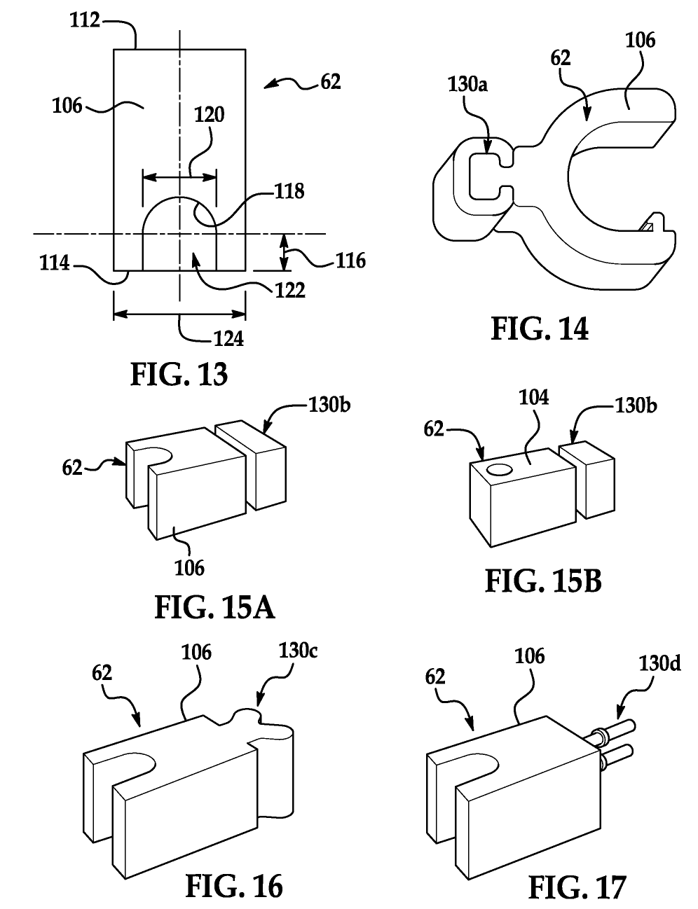

Referring now to FIG. 13, the drill guide portion 106 illustrates a back surface 112, a front face 114, a radius 1 16 of the drill guide surface 118, a width 120 of the drill guide slot 122, and a width 124 of the drill guide attachment 62. It should be recognized with respect to FIGS. 9A-13 that the distance between the back surface 112 of each drill guide 106, or locator guide 104, and the centerline of the longitudinal axis of the drill bit to be guided is constant, so that as each individual drill guide is substituted into an assembly with the corresponding anchor portion 102, the alignment of the centerline of the drill to be guided is maintained in the proper coaxial position with respect to the anchor portion 102. The radius 116 of the drill guide surface 118 extends from the centerline of the drill to be guided, and defines the outer dimension of the front face from the centerline of the drill to be guided. This configuration provides a visual confirmation that a drill is properly positioned within the drill guide 106 when the outer circumferential surface of the drill is aligned with the front face 114 of the drill guide 106.

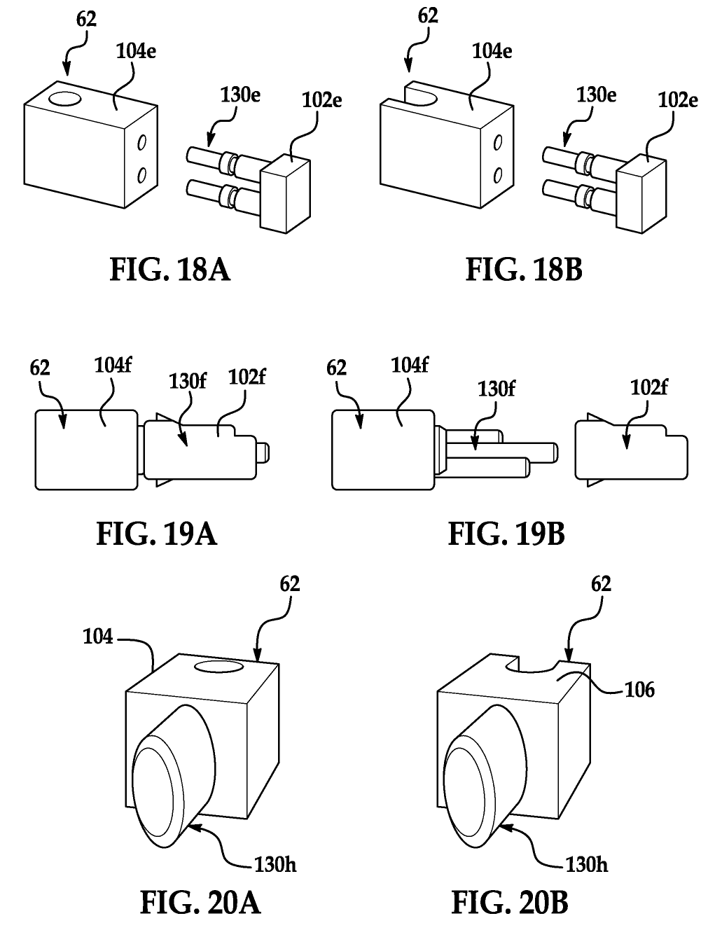

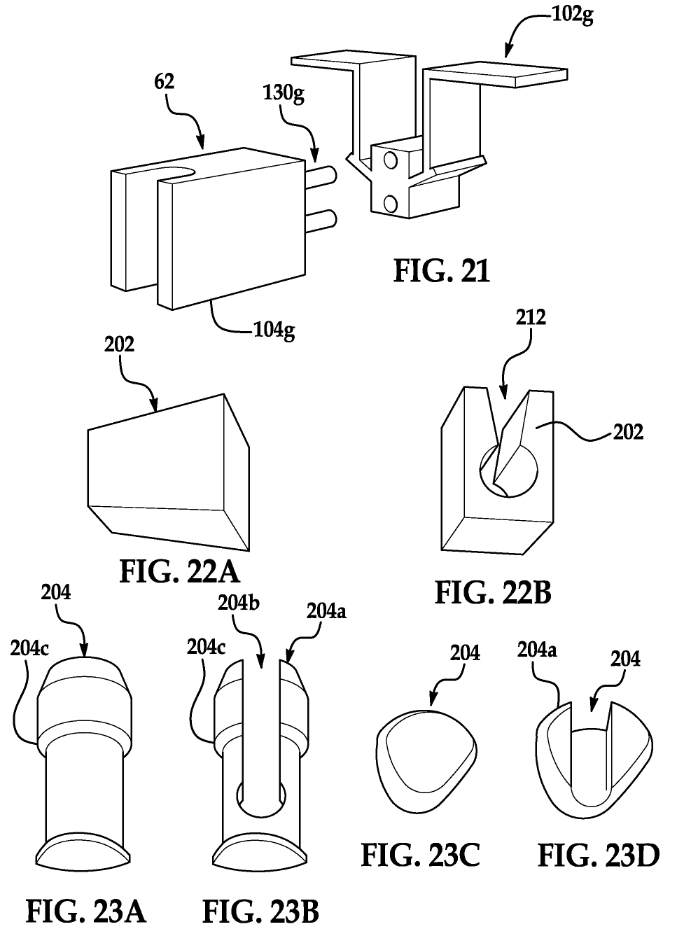

Referring now to FIGS. 14-21, a removable drill guide attachment 62 cooperatively secures one of a plurality of different size drill guide portions 106 to the material 20 when hardened. The attachment 62 is formed by at least one shaped interface surface 130 for supporting a locator portion 104 and/or a drill guide portion 106 with respect to the material when hardened. The removable drill guide attachment 62 can be selected from a complementary shaped interface surface 130 group including a cross-sectional T-shaped mount interface surface 130a, 130b as illustrated in FIGS. 14 and 15A-15B, a cross-sectional Y-shaped mount interface surface 130c as illustrated in FIG. 16, a multiple projection bayonet mount interface surface 130d, 130e, 130f, 130g as illustrated in FIGS. 17, 18A-18B, 19A-19B, and 21, a single projection bayonet mount interface surface 130h as illustrated in FIGS. 20A-20B, and any combination thereof.

Referring now to FIGS. 22A-22B, a drill guide anchor or base portion 202 is illustrated having a vertically extending key-hole-shaped slot 212. This configuration allows vertical adjustment of the locator portion 104 and/or drill guide portion 106 with respect to the anchor or base portion 202 while making the X-ray guide tray and/or surgical drill guide tray. After the vertical dimension is properly set with respect to the dental model, additional material 20 is applied within the slot 212 to define a complementary aperture for receiving the corresponding shaped portion of the replaceable locator guides 104 and/or drill guide portions 106. Alternatively, FIGS. 22A-22B can illustrate a preform anchor portion 202 illustrated in FIG. 22A for attachment to a locator guide 104, and a corresponding bayonet attachment portion 204 illustrated in FIG. 22B for engagement in the aperture formed material 20 of the guide tray with the preform anchor portion 202 after the preform has been removed. The slot 212 allows sufficient flexing movement of the outer walls of the bayonet portion 204 to permit insertion and frictional holding of the drill guide 106 attached to the bayonet portion 204.

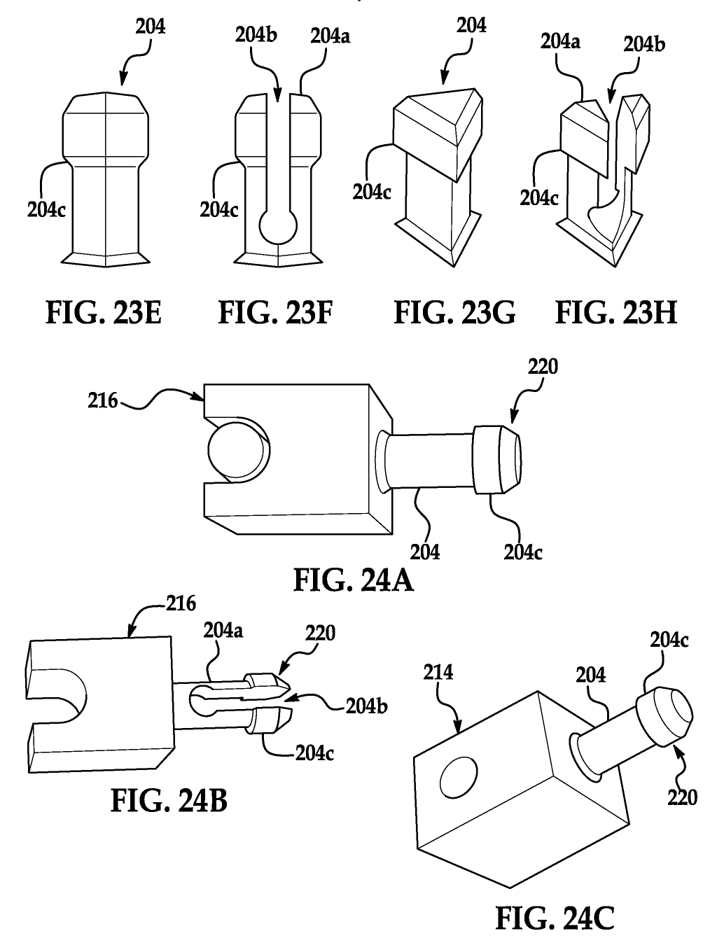

By way of example and not limitation, the following description describes various possible configurations of the complementary shaped replaceable portions for interlocking engagement between the anchor or base portion 102 and the locator guide portion 104 and/or the drill guide portion 106. FIGS. 23A-23H show a complementary non-circular bayonet shaped attachment portion 204 for connecting to the base portion 202 of FIGS. 22A-22B. The locator guide portion 104 can include a solid projection portion 204 for engagement within the slot 212 during formation of the X-ray guide tray and/or the surgical drill guide tray. After the desired vertical dimension has been set with respect to the dental model and the material 20 has hardened or been cured, the replaceable drill guide portions 106 can be provided with a sot 204b formed in the projection portion 204a to allow an interference or snap fit within the slot 212. The outer surface of the projection portion 204a can include an enlarged portion or ridge 204c to provide releasable resistance to the disassembly or dislodging movement of the drill guide portion 106 with respect to the slot 212 of the anchor portion 102 after assembly. FIGS. 24A-24C illustrate replaceable locator guides 214 and replaceable drill guides 216 using a bayonet shaped attachment portion 220 of the type shown in FIGS. 22A-23H.

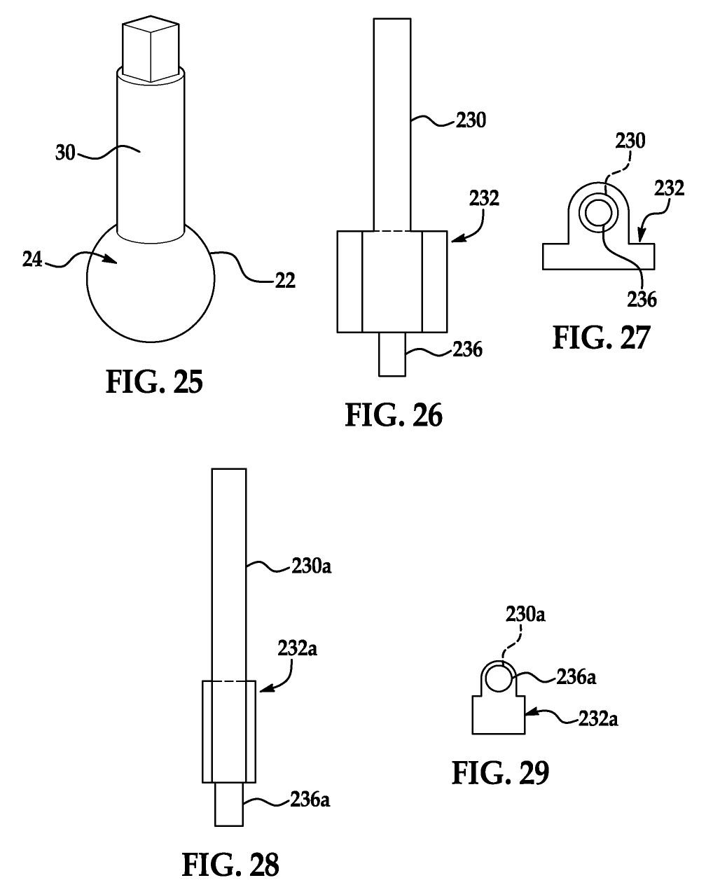

FIG. 25 illustrates a base portion or ball 22 and pin 30 combination with a shaped outer end 218 to allow use of a tool to securely seat the pin 30 with respect to the ball 22 and to adjust angulations of different size pins 30 with respect to the ball 22. The shaped outer end 218 can be any desired configuration suitable for engagement with a tool for removing the pin 30 with respect to the ball 22, or for adjusting the angulation of the pin 30 and ball 22 combination with respect to the dental model. By way of example and not limitation, the shaped outer end 218 can be rectangular or square as illustrated for engagement with a correspondingly sized wrench or socket.

FIG. 26 shows a front view of a pin 230 having an anchor preform 232 for forming an anchor portion 234 for a large size dental implant drill guide. The pin 230 can have a cylindrical stub 236 for engagement within a cylindrical aperture formed in the dental model, or for engagement with a cylindrical aperture formed in the spherical base portion or ball. FIG. 27 illustrates a bottom view of the pin 230 having the replaceable anchor perform 232 of FIG. 26 for a large size dental implant drill guide. The material 20 can be applied around the pin 230 and anchor preform 232 to form an X-ray guide tray or surgical drill guide tray when hardened. When hardened the material is separated from the pin 230 and the anchor preform 232, and a suitable surgical drill guide can be removably inserted into the anchor portion formed in the tray by the anchor preform.

FIG. 28 shows a front view of a pin 230a with a replaceable anchor perform 232a for a small size dental implant drill guide. The pin 230a can have a cylindrical stub 236a for engagement with a cylindrical aperture formed in the dental model, or for engagement with a cylindrical aperture formed in the spherical ball portion. FIG. 29 illustrates a bottom view of the pin 230a with a replaceable anchor perform 232a of FIG. 28 for a small size dental implant drill guide. As previously described, the material 20 can be applied around the pin 230a and anchor preform 232a to form an X-ray guide tray or surgical drill guide tray when hardened. When hardened the material is separated from the pin 230a and the anchor preform 232a, and a suitable surgical drill guide can be removably inserted into the anchor portion formed in the tray by the anchor preform.

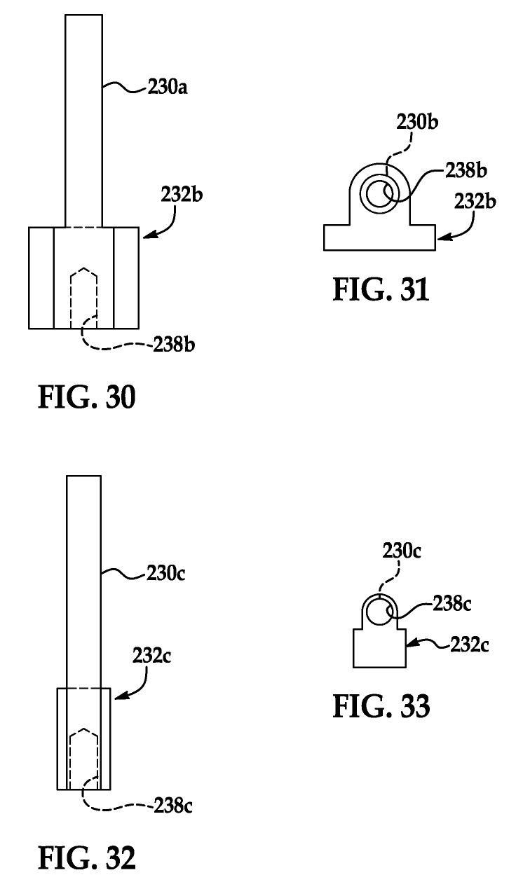

FIG. 30 shows a front view of a pin 230b with an anchor perform 232b for forming an anchor portion for a large size dental implant drill guide. The pin 230b can have a cylindrical aperture 238b for engagement with a cylindrical stub supported from the dental model, or for engagement with a cylindrical stub supported from the spherical ball portion. FIG. 31 is a bottom view of the pin 230b having a replaceable anchor perform 232b of FIG. 30 for a large size dental implant drill guide. As previously described, the material 20 can be applied around the pin 230b and anchor preform 232b to form an X-ray guide tray or surgical drill guide tray when hardened. When hardened the material is separated from the pin 230b and the anchor preform 232b, and a suitable surgical drill guide can be removably inserted into the anchor portion formed in the tray by the anchor preform.

FIG. 32 shows a front view of a pin 230c having a replaceable anchor perform 232c for a small size dental implant drill guide. The pin 230c can have a cylindrical aperture 238c for engagement with a cylindrical stub supported from the dental model, or for engagement with a cylindrical stub supported from the spherical ball portion. FIG. 33 illustrates a bottom view of the pin 230c with a replaceable anchor perform 232c of FIG. 32 for a small size dental implant drill guide. As previously described, the material 20 can be applied around the pin 230c and anchor preform 232c to form an X-ray guide tray or surgical drill guide tray when hardened. When hardened the material is separated from the pin 230c and the anchor preform 232c, and a suitable surgical drill guide can be removably inserted into the anchor portion formed in the tray by the anchor preform.

In FIGS. 26-33, the anchor portion 102 can be formed by the material 20 applied around the desired anchor preform shape and size. The interchangeable and replaceable locator guide portions 104 and drill guide portions 106 can be attached directly to the correspondingly shaped anchor portion 102 defined by the hardened or cured material 20. It should be recognized that the anchor portion 102 defined by the hardened or cured material 20 can be any desired interlocking complementary shape with the particular locator guide portions 104 and/or drill guide portions 106 to be used for a surgical procedure on a particular patient, and should not be considered to be limited to the generally T-shaped anchor configurations illustrated in FIGS. 26-33. Any shape suitable for releasable attachment can be used with the anchor portion 102 formed by the hardened or cured material 20, including any of the configurations of complementary shaped attachments shown in the other Figures and described above, if desired.

The X-ray guide kit can include: (1) a clear X-ray guide impression tray; (2) a positioning/orientation ball and pin combination; and (3) an X ray pin of metal or X-ray opaque material to confirm spacing/positioning/orientation with respect to the patient prior to constructing the drill guide. The X-ray guide impression tray can be used to define a frame of an X-ray guide body. The impression tray is used for convenience, and it should be recognized that an X-ray guide body can be made without using an X-ray guide impression tray if desired. Different commercially available materials can be used to create the frame of the X-ray guide body if desired.

The positioning/orientation ball and pin combination can include various size locator spheres with a removable pin longer than an X-ray pin (2.2 millimeters or other set diameter with 2 millimeter or other set diameter insertion section and 20 millimeter or other set length). The locator sphere is used for positioning and spacing of implants; so the diameter of the locator sphere can be determined by the implant size. The pin is used to determine the angulations of the implant placement. Various material and combination of materials can be used for the ball and pin combination. The sphere and pin can be made as a single integral part, or an insertion portion of the pin can be threaded or friction fit into the sphere portion. An X-ray pin can be made of metal, or any other radio opaque material can be used. The X-ray pin can be 10 millimeters or other set length (i.e. shorter than the positioning/orientation pin and 2.2 millimeters or other set diameter (i.e. the same as the positioning/orientation pin but without an insertion portion to interact with the sphere). The X-ray pin sits on top of the sphere or ball, and is not inserted into the ball.

A procedure for creating an X-ray guide according to the invention can include the following steps: (1) take an impression of the patient's mouth, and create a dental model; (2) mark the dental model to locate the ideal positioning of implant or implants for the best esthetic result; (3) use a pilot drill, drill a pilot hole in the dental model at the marked position, then, make the pilot hole larger and deeper using a round ball drill with a diameter corresponding with the implant size; (4) cut back a tray to expose a desired implant placement area; (5) use a set of positioning/orientation sphere and pin, and set orientation of the implant insertion esthetically ideal for the dental restoration; (6) apply impression material (clear PVS is desirable) on X-ray guide impression tray, firmly place the implant/impression tray on the dental model, put PVS material around the pin(s), and the tray; (7) when the material around the pin(s) hardens, detach the spacing/positioning/orientation pin(s) from the sphere(s), and pull out the pin(s) from the tray keeping the tray in the same position, replace the positioning/orientation pin(s) with X-ray pin(s), make sure the X-ray pin(s) sit(s) on top of the sphere(s) (i.e. the top of sphere corresponds to a gum line of the patient); (8) place the tray in the patient's mouth hold an X-ray film or a digital device against the flat wall of the X-ray tray (adhesive can be used to attach the film in place), and take X-ray photos; and (9) evaluate the positioning and the angulations of the pin(s), if the positioning is satisfactory, place the positioning/orientation pin(s) back into the spheres on the dental model. The verified model can be used as a device to create a surgical guide as described in greater detail below. (10) If the positioning needs adjustment, remove PVS material around the X-ray pin(s); release positioning/orientation sphere(s) from the model, attach positioning/orientation pin(s) to the sphere(s), and re-mount the sphere(s) in a new adjusted, corrected position. Repeat steps 6 to 9 until the desired result is achieved.

The surgical guide kit can include (1) a surgical guide impression tray; (2) a spacing/positioning/orientation sphere and pin (needed if an X-ray guide has not previously been made as described above); and (3) at least one surgical guide attachment. The surgical guide impression tray can be used to define a frame of a surgical guide body. The impression tray is used for convenience, and it should be recognized that a surgical guide body can be made without using a surgical guide impression tray if desired. Different commercially available materials can be used to create the frame of the surgical guide body if desired.

A spacing/positioning/orientation sphere and pin can be provided as described in greater detail above with respect to the X-ray guide impression tray kit. The sphere and pin combination can be the same ones as used to create the X-ray guide as described above, when proceeding with the creation of a surgical guide after completion of the X-ray guide. An additional sphere and pin combination is needed only if X Ray Guide was not previously made.

At least one surgical guide attachment is placed with respect to the surgical guide body and is used to establish the location and angulation of a surgical guide with a locator attachment, or to guide different sizes of surgical drills for implant placement with a guide attachment. The different parts of the surgical guide can be made from different materials and/or different combination of materials, by way of example and not limitation metal, plastic, ceramic, and any combination thereof The attachments are provided in three different types or styles: (1) a fixed attachment with various size drill guide apertures embedded in material defining the surgical guide body; (2) a removable attachment with various widths and various size drill guide apertures interchangeable with complementary shaped base portions secured to the surgical guide body; and (3) a removable attachment with fixed widths and various size drill guide apertures interchangeable with complementary shaped base portions secured to the surgical guide body.

A fixed attachment can be buried in the surgical guide body in a non-removable manner. Multiple guides can be made to accommodate different size surgical drills required for the implantation procedure. This type of fixed attachment is provided with different diameter guide pins and with different complementary insertion portions to fit with respect to a positioning/orientation sphere or with different complementary guide tube portions to fit with respect to a spacing/positioning/orientation pin. The diameter of the pins corresponds with the surgical drills necessary for the implantation procedure for a particular patient. This type of attachment does not require a locator attachment, since the fixed attachment is not interchangeable after being embedded in the material forming the surgical tray and an aperture formed in each fixed attachment acts as the drill guide during the surgical dental implantation procedure. A distance between a back surface of each attachment and a center of the corresponding aperture or slot is not critical, since positioning of each attachment is verified with the positioning/orientation pin on the dental model during creation of the particular surgical tray.

A procedure with fixed attachment can include some or all of the following steps as required depending on the previous steps, if any, and depending on the particular dental implant surgery drill guide requirements. First, if a dental model with verified spacing/positioning/orientation sphere and pin combination has not been made as described above, prepare the dental model as described above for the X-ray guide. Second, take an impression of the dental model with a surgical guide tray, and cut out a portion of the tray so that an area of implant placement is exposed. The tray can be cut back before PVS application if desired. If an X-ray guide is being made, a surgical guide impression should be taken at the same time the X-ray guide impression is taken. In case a spacing/positioning/orientation sphere and pin combination has already been placed on the dental model, cut out the tray before applying PVS material. Third, set orientation of the implant insertion with a spacing/positioning/orientation sphere and pin combination like described above in the procedure for the X Ray Guide, if it has not been done yet. Fourth, take impressions with as many surgical guide trays as the number of surgical drills that will be used for the implant placement. Fifth, replace spacing/positioning/orientation pin(s) with the smallest guide pin with the size of the smallest surgical drill used for the implant placement. Sixth, firmly place the surgical guide impression tray on the dental model, place the guide attachment for the same guide pin(s) in position so that the attachment(s) would rest on the spacing/positioning/orientation sphere. Put acrylic, light cure composite, or PVS or other suitable material around the attachment(s) and the tray, encapsulate the attachment(s), and make sure the attachments are secure in place. When the material hardens, take out the guide pin(s), and remove the surgical guide from the dental model. Seventh, place the next size guide pin(s) into the positioning/orientation sphere, and repeat the above procedure with a new surgical guide impression tray and the next size surgical guide. Make as many surgical guides as needed for the particular dental implant surgery for the patient.

A removable attachment having a fixed width can be provided with different width size sets. A small width set can be used for anterior region implant placement, and a medium width set and/or a large width set can be used for posterior region implant placement. Each removable attachment set has a fixed width regardless of the size of locator aperture or drill guide slot. These types of attachments can be used to create a guide with removable attachments, and are designed to encapsulate the attachment for additional stability. These attachments include three parts: (1) a drill guide attachment body having an aperture or a slot; (2) a first complementary attachment portion, either male or female, connected to the attachment body; and (3) a second complementary attachment portion, either male or female, sometimes referred to herein as an anchor portion or base portion to be buried in a body of the surgical guide. The attachment body and first complementary attachment portion are fixed together or can be formed as one piece or separate pieces assembled together. Each attachment body has a uniform fixed height independent of the drill guide aperture or slot size. The complementary male and female attachments can be any desired configuration, by way of example and not limitation, T-shaped portion and slot, Y-shaped portion and slot, single bayonet shaped portion and slot, a plurality of bayonet shaped portions and slots, and any combination thereof.

An anchor or base portion can have a complementary shape, either male or female, with respect to a locator attachment and/or a guide attachment to be connected thereto. A locator attachment can have a complementary shape, either male or female, with respect to the corresponding base or anchor portion, an aperture formed in the locator attachment with the same diameter as the spacing/positioning/orientation pin, and the same width as guide attachments of the same size set. A drill guide attachment can have a slot with half circle stop. The diameter of the half circle or slot width varies, but the overall width of the attachment for different size drills is the same within a particular set. A width of the guide attachment is approximately 4.8 millimeters for a small size set, and approximately 6.2 millimeters for a large size set. The length of the attachments varies, but a distance between a back surface of the locator attachment and corresponding drill guide attachment for the particular set size and a center of the aperture or slot is the same.

A removable attachment has various widths depending on the size of locator aperture or drill guide slots. The attachment includes three parts: (1) a drill guide attachment body having an aperture or a slot; (2) a first complementary attachment portion, either male or female, connected to the attachment body; and (3) a second complementary attachment portion, either male or female, sometimes referred to herein as an anchor portion or base portion to be buried in a body of the surgical guide. The attachment body and first complementary attachment portion are fixed together or can be formed as one piece or separate pieces assembled together. Each attachment body has a uniform fixed height independent of the drill guide aperture or slot size. The complementary male and female attachments can be any desired configuration, by way of example and not limitation, T-shaped portion and slot, Y-shaped portion and slot, single bayonet shaped portion and slot, a plurality of bayonet shaped portions and slots, and any combination thereof. A locator attachment can have an aperture with the same diameter as the spacing/positioning/orientation pin, by way of example and not limitation, such as a 4 millimeter or other set dimension. A guide attachment can have a slot with a half circle stop. The diameter of the half circle or the slot width varies, and corresponds with a diameter of the surgical drills to be used for implant placement during the surgical procedure. Since multiple size drills can be used to place an implant, multiple guide attachments can be used for a single surgery. A width of the guide attachment can be 2 millimeters larger than a size of a width of a drill guide slot, by way of example and not limitation, such as approximately 1 millimeter wall on each side of the slot. The length of the attachment can be varied, but for the entire set of a particular size of the attachments, the length between a back surface of each attachment and a center of the drill guide aperture or slot is the same.

A procedure with a removable attachment can include some or all of the following steps as required depending on the previous steps, if any, and depending on the particular dental implant surgery drill guide requirements. First, if a dental model with verified spacing/positioning/orientation sphere and pin combination has not been made, prepare the dental model as described above with respect to the procedure for an X Ray Guide. Second, take an impression of the dental model with a surgical guide tray, and cut out the tray so that an area of implant placement is exposed. The tray can be cut back before PVS application if desired. If an X-ray guide is being made, a surgical guide impression should be taken at the same time as the X-ray guide impression is taken. In case a spacing/positioning/orientation sphere and pin combination has been already placed on the dental model, cut out the tray before applying PVS material. Third, set orientation of the implant insertion with a spacing/positioning/orientation sphere and pin combination as described above with respect to the procedure for an X-ray guide, if it has not been done yet. Fourth, firmly place the implant/impression tray on the dental model, place locator attachment(s) in position so that the attachment(s) would rest on the positioning/orientation sphere. Put acrylic, light cure composite, or PVS, or other suitable material, around the attachment(s) and the tray, and secure the attachment(s). If the attachments are removable, apply the material only on the anchor or base attachment portions and along a back surface of the attachment body or bodies. Do not surround either side of the body of locator attachment(s) with the material. When the material hardens remove the positioning/orientation pins. Now, the locator attachment(s) can be replaced with drill guide attachment(s) of various sizes as required for the particular dental implant surgery procedure.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. In a kit for performing a dental procedure relating to replacement of teeth including a dental model of a particular mouth formation of a patient and an intended dental implant location with respect to the dental model, the improvement comprising:
at least one reference member to be supported by a dental model in an adjustable angulation and dimensional position at an intended dental implant location.

2. The improvement of claim 1, wherein the at least one reference member her comprises:
a base member having at least a partial spherical surface for engagement within an aperture formed in the dental model with a round ball drill and having a pin-supporting structure; and
a pin to be supported by the pin-supporting structure of the base member.

3. The improvement of claim 2, wherein the base member is substantially spherically shaped.

4. The improvement of claim 2, wherein the pin is releasibly engageable with the pin-supporting structure.

5. The improvement of claim 4, wherein the pin is engaged with the pin-supporting structure of the base member by a threaded connection.

6. The improvement of claim 4, wherein the pin is engaged with the pin-supporting structure of the base member with a friction fit.

7. The kit of claim 1 further comprising:
an adhesive for releasibly securing the at least one reference member in the desired angulation and dimensional position with respect to the dental model.

8. The kit of claim 7 further comprising:
an adhesive release agent to be applied to the dental model to release the at least one reference member for readjustment of the angulation and dimensional position or for removal of the at least one reference member.

9. The kit of claim 1 further comprising:
a material to be applied around the at least one reference member for supporting the at least one reference member when the material has hardened, the material forming an impression of teeth and gums of a particular mouth formation of a patient and an intended dental implant location with respect to the dental model.

10. The kit of claim 9 further comprising:
an impression tray to be formed with respect to a dental model made from an impression of teeth and gums of a particular mouth formation of a patient, and an appropriate portion of the tray cut back to expose an intended dental implant location with respect to the dental model; and
the material to be applied to the impression tray prior to placement on the dental model and within the cut back portion of the tray to support the reference member when the material has hardened.

11. The kit of claim 10, wherein the impression tray is an X-ray guide impression tray and, further comprising:
at least one X-ray visible reference member to be substituted for each reference member and to be supported by the X-ray guide impression tray for transfer to the mouth of the patient for X-ray confirmation of the angulation and dimensional position of the at least one X-ray reference member.

12. The kit of claim 10, wherein the impression tray is a surgical guide impression tray and, further comprising:
at least one drill guide having a surface supported by the surgical guide impression tray and adapted to be contacted by a dental drill tool to govern movement of the dental drill tool facilitating replacement of teeth; and
structure for cooperatively securing a drill guide to the surgical guide impression tray, the structure formed by material to be applied to the surgical guide impression tray prior to placement on the dental model and to be applied around the at least one drill guide for supporting the at least one drill guide within the cut back portion of the tray when the material has hardened.

13. The kit of claim 9 further comprising:
at least one drill guide having a shaped surface to be supported by the material when hardened and adapted to be contacted by a dental drill tool to govern movement of the dental drill tool facilitating replacement of teeth.

14. The kit of claim 13 further comprising:
a removable drill guide attachment structure for cooperatively securing one of a plurality of different size drill guides to the material when hardened, the structure formed by at least one complementary shaped interface surface for supporting the at least one drill guide with respect to the material when hardened.

15. The kit of claim 14, wherein the removable drill guide attachment structure is selected from a complementary shaped interface surface structure group consisting of a single projection bayonet mount extending generally perpendicular to a longitudinal axis defined by the drill guide, a multiple projection bayonet mount extending generally perpendicular to the longitudinal axis defined by the drill guide, a cross-sectional T-shaped mount defined generally perpendicular to the longitudinal axis of the drill guide, a generally rectangular-shaped mount extending generally perpendicular to a longitudinal axis defined by the drill guide, a generally triangular-shaped mount extending generally perpendicular to a longitudinal axis defined by the drill guide, and a cross-sectional Y-shaped mount defined generally perpendicular to the longitudinal axis of the drill guide.

16. In a kit for performing a dental procedure relating to replacement of teeth including a dental model of a particular mouth formation of a patient and an intended dental implant location with respect to the dental model, the improvement comprising:
at least one reference member to be supported by a dental model in a desired angulation and dimensional position at an intended dental implant location, the at least one reference member including an anchor portion preform.

17. The kit of claim 16 further comprising:
a material to be applied around the at least one reference member and the anchor portion preform for supporting the at least one reference member and defining a releasable interlocking surface of an anchor portion when the material has hardened, the material forming an impression of teeth and gums of a particular mouth formation of a patient and an intended dental implant location with respect to the dental model.

18. The kit of claim 17 further comprising:
an interchangeable drill guide having a complementary interface surface for releasable engagement with respect to the interlocking surface of the anchor portion.

19. In a kit for performing a dental procedure relating to replacement of teeth including a dental model of a particular mouth formation of a patient and an intended dental implant location with respect to the dental model, the improvement comprising:
at least one reference member to be supported by a dental model in a desired angulation and dimensional position at an intended dental implant location;
an anchor portion to positioned at an intended dental implant location, the anchor portion defining a stable interlocking joint in at least two orthogonal directions while allowing releasable attachment in a third orthogonal direction extending between the lingual and palatal regions and generally parallel to the occlusal plane;
a locator guide portion to be supported by the at least one reference member and a complementary interface surface with respect to the interlocking joint of the anchor portion during formation of a dental impression guide tray; and
a drill guide portion having a complementary interface surface with respect to the interlocking joint of the anchor portion to be substituted for the locator guide portion after formation of the dental impression guide tray.

20. The kit of claim 19, wherein the stable interlocking joint is selected from a group consisting of a single projection bayonet mount extending generally perpendicular to a longitudinal axis defined by the drill guide, a multiple projection bayonet mount extending generally perpendicular to the longitudinal axis defined by the drill guide, a generally rectangular-shaped mount extending generally perpendicular to a longitudinal axis defined by the drill guide, and a generally triangular-shaped mount extending generally perpendicular to a longitudinal axis defined by the drill guide.
